(19) United States
(12) Patent Application Publication
(10) Pub. No.: US 2025/0156975 A1
(43) Pub. Date: May 15, 2025

(54) CAREER BRIDGE

(71) Applicant: Jose Eloy Garza, Pharr, TX (US)

(72) Inventor: Jose Eloy Garza, Pharr, TX (US)

(21) Appl. No.: 18/389,044

(22) Filed: Nov. 13, 2023

Related U.S. Application Data
(60) Provisional application No. 63/406,901, filed on Sep. 15, 2022.

(51) Int. Cl. G06Q 50/20

(52) U.S. Cl. CPC G06Q 50/2057

(57) ABSTRACT

The Career Bridge APP helps educators develop, facilitate, and manage, work-based learning, internship, practicum, capstone, and career preparation programs. The Career Bridge App provides users with the user-specific milestones they need to complete to be engaging and compliant within the program while gathering and storing the data needed for reporting. Most importantly, Career Bridge provides a powerful and secure communication/collaboration environment that allows students, academics and business professionals to communicate with each other in a transparent and controlled environment. Additionally, it provides business/community members who are engaged in the program the ability to rate and provide feedback on student performance and artifacts which further supports educators' efforts and student growth.

This application relates back to U.S. 63/406,901 filed on Sep. 13, 2022 and is incorporated in its entirety.

### FIELD OF THE INVENTION

This invention relates generally to methods and devices designed to facilitate a work-based learning management system and method which allows educators to develop, facilitate, track, and manage, internship, apprenticeship, mentorship, practicum, capstone, and career preparation programs.

### BACKGROUND

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

Student participation in work-based learning is referenced in federal legislation as a key indicator of quality programing in educational programs that are focused on career preparation. Such programs include internship, apprenticeship, mentorship, practicum, capstone, and career preparation programs in order to prepare students for the workforce. These programs require that educators implement, gather, and maintain additional documentation and records in order to track and monitor student/program performance. Additionally, educators must maintain constant communication with students and the business/community members who are engaged in these programs.

Traditionally, educators use whichever means they can to implement, track, and monitor these programs. Work-based learning programs require additional data gathering, reporting, and management which is laborsome to implement and track. This usually involves antiquated and laborious practices that require a lot of printing, collecting, scanning, and recording of documentation which may additionally need to be manually inputted into digital spreadsheets or reports. Communication among stakeholders has also traditionally been done via phone calls, emails, postal services, and in-person. A need exists for an improved way to develop, facilitate, track, and monitor these programs.

According to a preferred embodiment, a presently disclosed work-based learning management system and method, allows educators to develop, facilitate, track, and manage, internship, apprenticeship, mentorship, practicum, capstone, and career preparation programs. It provides users with the user-specific information they need to be part of an engaging and compliant program while gathering and storing the data needed for reporting.

### SUMMARY OF THE INVENTION

Career Bridge is a Work-based Learning Management System designed to help educators, students, and business professionals work together on student projects. It does this by providing a safe and transparent digital environment that facilitates the development and management of work-based learning, internship, practicum, problem-based learning, project-based learning, and capstone projects.

According to some embodiments, a presently disclosed work-based learning management system and method, Career Bridge, provides a powerful communication/collaboration environment that allows users to communicate with each other in a transparent and controlled environment. Additionally, it provides business/community members who are engaged in the program the ability to rate and provide feedback on student performance and artifacts which further supports educators' efforts and student growth.

As a progressive web app. Career Bridge is available/compatible on any mobile device and computer for easy access. The system provides a framework that allows educators to break student projects down into manageable milestones. Each milestone provides user-specific information with descriptions, due dates, expectations, support resources (videos/tutorials/documents/materials), and tasks needing completion. Additionally, educators can tag educational standards and/or learning outcomes within projects and milestones. This provides the ability for educators to quantify and measure student learning outcomes. All essential information needed to track and manage the project is gathered in the system and securely managed for educators.

Career Bridge allows users to communicate and collaborate among themselves in a safe and transparent environment. “Team Chat” provides a communication tool that allows teachers and students the ability to communicate/collaborate on project matters. “Business Chat” provides a communication tool that allows students and teachers to collaborate with business professionals who are engaged in the project. All contact information is kept private and users can receive notifications of correspondence via push notification and/or email. Educators and administrators have full access and oversight to all communications thereby enhancing transparency. All in-app notifications are done via push notification and/or email as well without sharing contact information.

Career Bridge also has the ability for students to submit “deliverables” or project artifacts (videos, documents, or images) to educators and business professionals for formative feedback and review during each milestone. Once a deliverable is submitted it automatically creates a Rate/Review task needing to be completed for the business professional. Business professionals can review/download deliverables and submit a rating/feedback form based on simple five-star scales and rubrics that provides the educators/students with invaluable information towards project progress. Students are also given the ability to provide self reflections of their own learning versus the project/milestone learning objectives.

All users can create a robust digital portfolio to share with other users. Users can provide information, videos, media, and past works/artifacts to showcase their skills, accomplishments, qualifications, and experience.

Career Bridge helps educators develop, facilitate, and manage, work-based learning, internship, practicum, capstone, and career preparation programs. It provides users with the user-specific information they need to be part of an engaging and compliant program while gathering and storing the data needed for reporting. Most importantly, Career Bridge provides a powerful communication/collaboration environment that allows users to communicate with each other in a transparent and controlled environment. Additionally, it provides business/community members who are engaged in the program the ability to rate and provide feedback on student performance and artifacts which further supports educators' efforts and student growth.

### BRIEF DESCRIPTIONS OF THE DRAWINGS

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale

FIGS. 1-2 depict a work-based learning management system and method according to some embodiments presently disclosed.

FIG. 3 depicts a milestone learning management system and method according to some embodiments presently disclosed.

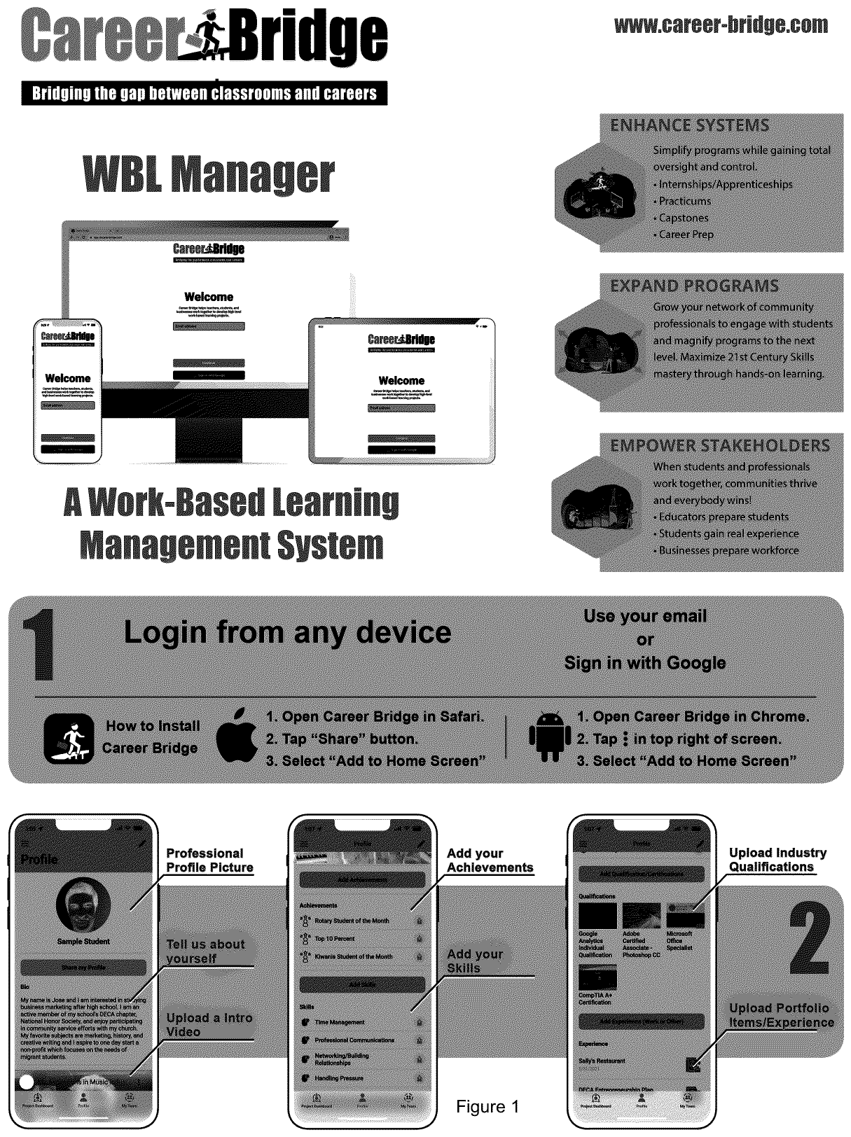

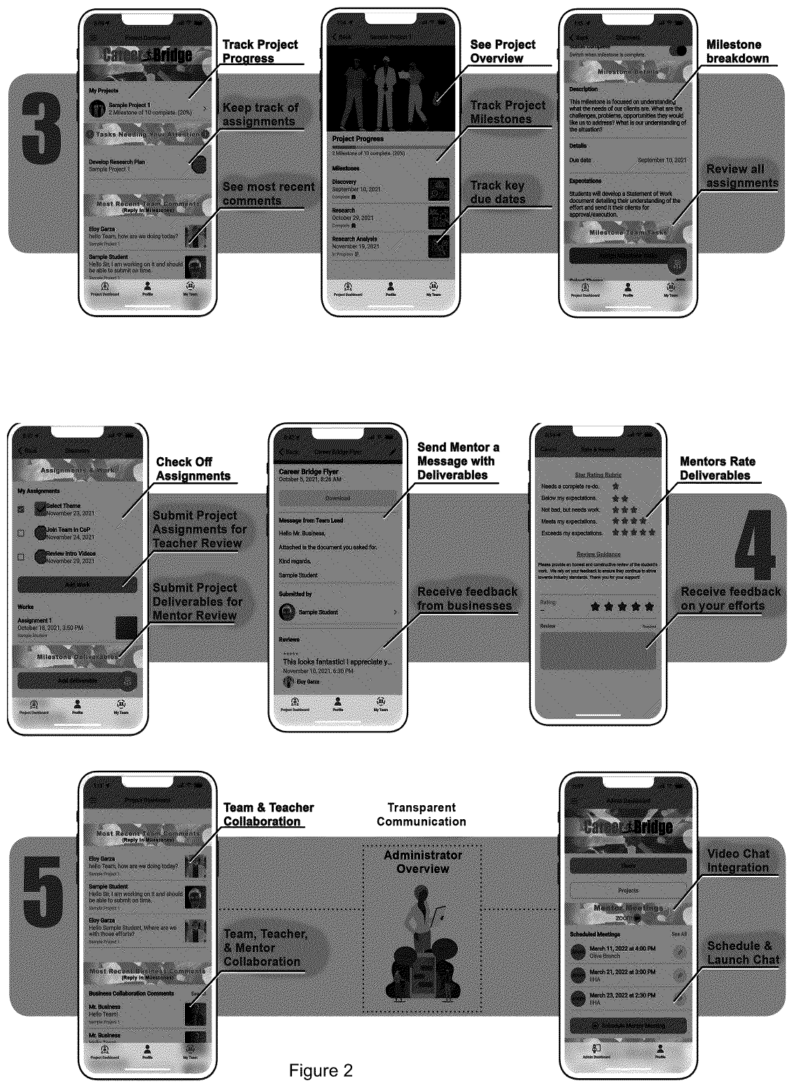

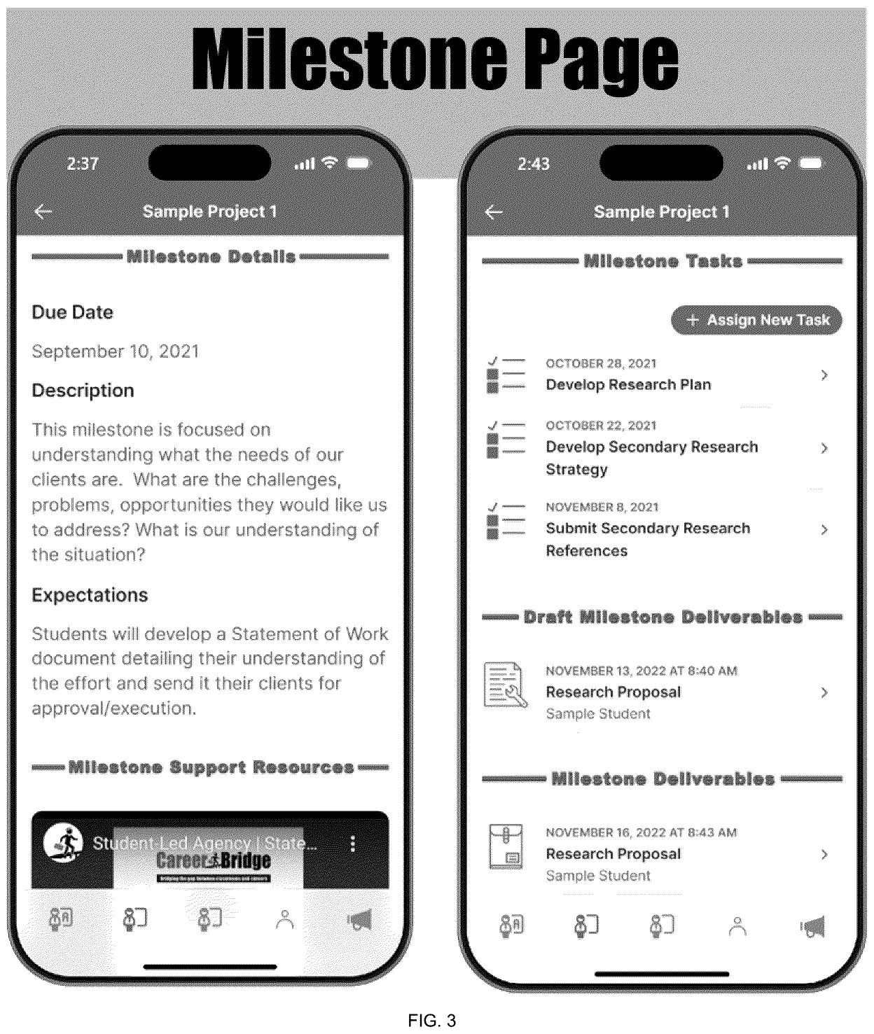

### DETAILED DESCRIPTION OF THE INVENTION

According to some embodiments, presently disclosed is Career Bridge, a work-based learning management system and method which allows educators, students, and business professionals to work together on student projects. It does this by providing a safe and transparent digital environment that facilitates the development and management of internship, apprenticeship, mentorship, practicum, problem-based learning, project-based learning, and capstone projects.

According to some embodiments, presently disclosed is a Career Bridge APP, a work-based learning management system and method that may be implemented on any mobile device and computer for easy access. The presently disclosed system provides a framework that allows educators to break student projects down into manageable milestones. Each milestone provides user-specific information with descriptions, due dates, expectations, support resources (videos, tutorials, documents, materials), and tasks needing completion. All essential information needed to track and manage the project may be gathered in the system and securely managed for educators.

According to some embodiments, presently disclosed work-based learning management system and method allows users to communicate and collaborate among themselves in a safe and transparent environment. According to some embodiments, presently disclosed work-based learning management system provides a communication tool that allows teachers and students the ability to communicate/collaborate on project matters. According to some embodiments, presently disclosed work-based learning management system provides a communication tool that allows students and teachers to collaborate with business professionals who are engaged in the project. All contact information is kept private and users can receive notifications of correspondence via push notification and/or email. According to some embodiments, presently disclosed work-based learning management system may allow educators and administrators to have full access and oversight to all communications thereby enhancing transparency. All in-app notifications may be done via push notification and/or email as well without sharing contact information. According to some embodiments, presently disclosed work-based learning management system may also have the ability to schedule and host online video meetings through a Zoom integration that are automatically recorded for transparency and future reference.

According to some embodiments, presently disclosed work-based learning management system may allow students to submit “deliverables” or project artifacts (videos, documents, or images) to the business professionals for feedback and review during each milestone. Once a deliverable is submitted it may automatically create a Rate/Review task needing to be completed for the business professional. Business professionals can review/download deliverables and submit a rating/feedback form based on simple five-star scales and rubrics that provides the educators/students with invaluable information towards project progress.

According to some embodiments, presently disclosed work-based learning management system may allow user(s) to create a robust digital portfolio to share with other users. Users can provide information, videos, media, and past works/artifacts to showcase their skills, accomplishments, qualifications, and experience.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

### OTHER EMBODIMENTS

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . .”

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

1. A work-based learning management system and method, Career Bridge, enables educators to develop, facilitate, track, and manage career preparation programs.

2. The work-based learning management system of claim 1, which allows educators, students, and business professionals to work together on student projects.

3. The work-based learning management system of claim 1, wherein said Career Bridge is an APP that may be implemented on any mobile device and computer for easy access.

4. The work-based learning management system of claim 1, wherein said Career Bridge APP provides a framework that allows educators to break student projects down into manageable milestones.

5. The work-based learning management system of claim 4, wherein said milestones provide user-specific information with descriptions, due dates, expectations, support resources (videos, tutorials, documents, materials), and tasks needing completion.

6. The work-based learning management system of claim 1, wherein said Career Bridge APP allows users to communicate and collaborate among themselves in a safe and transparent environment.

7. The work-based learning management system of claim 3, wherein said Career Bridge App, opens to “Team Chat” which provides a communication tool that allows teachers and students the ability to communicate/collaborate on project matters.

8. The work-based learning management system of claim 1, wherein said Career Bridge App opens to “Business Chat” which provides a communication tool that allows students and teachers to collaborate with business professionals who are engaged in the project.

9. The work-based learning management system of claim 4 or 8, wherein said Career Bridge App may allow students to submit “deliverables” or project artifacts (videos, documents, or images) to the business professionals for feedback and review during each said milestone.

10. The work-based learning management system of claim 9, wherein when said deliverable is submitted it may automatically create a Rate/Review task needing to be completed by the business professional.

11. The work-based learning management system of claim 7, wherein Business professionals can review/download deliverables and submit a rating/feedback form based on simple five-star scales and rubrics that provides the educators/students with invaluable information towards project progress.

12. The work-based learning management system of claim 3, wherein said Career Bridge App's in-app notifications are done via push notification and/or email as well without sharing contact information.

13. The work-based learning management system of claim 3, wherein said Career Bridge App may allow user(s) to create a robust digital portfolio to share with other users.

14. The work-based learning management system of claim 14, wherein said robust digital portfolio allows users to provide information, videos, media, and past works/artifacts to showcase their skills, accomplishments, qualifications, and experience.
